(19) United States
(12) Patent Application Publication
(10) Pub. No.: US 2012/0090902 A1
(43) Pub. Date: Apr. 19, 2012

(54) TOUCH PAD

(75) Inventors: Yung-Lung Liu, Ta Ya Shiang (TW); Shih-Pin Lin, Ta Ya Shiang (TW); Chun-Jung Liao, Ta Ya Shiang (TW)

(73) Assignee: Sunrex Technology Corp., Ta Ya Shiang (TW)

(21) Appl. No.: 12/903,231

(22) Filed: Oct. 13, 2010

(51) Int. Cl. G06F 3/041

(52) U.S. Cl. 178/18.03

(57) ABSTRACT

A touch pad includes a bottom substrate formed of plastic material; a second conduction layer adhered to the bottom substrate; a plurality of spaced pressing structures formed on the second conduction layer and each comprising a sensing layer adhered to the second conduction layer, a contact layer formed of flexible resistive or piezoelectric material and adhered to the sensing layer, and a connection layer adhered to the contact layer; a first conduction layer adhered to the pressing structures; and a top substrate formed of plastic material and adhered to the first conduction layer.

### BACKGROUND OF THE INVENTION

1. Field of Invention

The invention relates to computer keyboards and more particularly to a touch pad with improved characteristics.

2. Description of Related Art

Touchscreens and touch pads as input devices are becoming increasingly popular in the fields of computers, cellular phones, etc. because of their ease and versatility of operation. For example, touchscreen allows a user to interact directly with what is displayed on the screen (i.e., touching the screen with a finger). Further, touch pad allows a user to make selections and move a cursor by simply moving one finger thereon. It is similar to computer mouse operation.

There are several types of touchscreen and touch pad technologies including resistive, capacitive, etc. Each of these devices has advantages and disadvantages. Currently, resistive touchscreens are the most widely used. For touchscreens, there are 4-wire resistive touchscreens, 5-wire resistive touchscreens, and 8-wire resistive touchscreens available. In particular, 4-wire resistive touchscreens have about half of the market share because of the mature technology and cost consideration. For a typical 4-wire resistive touchscreen, one sheet is ITO (Indium Tin Oxide) glass, the other sheet is ITO film, and an insulating spacer for separation is disposed therebetween. Otherwise, short circuit may occur.

In detail, a typical resistive touch pad comprises, from top to bottom, a top substrate, a first conduction layer adhered to the top substrate, a first sensing layer adhered to the first conduction layer, a second sensing layer spaced apart from the first sensing layer by a distance, a second conduction layer adhered to the second sensing layer, and a bottom substrate. A touch signal is generated when the first and second sensing layers contacts each other due to finger pressing. A processor will process the signal. However, no touch signal is generated if sufficient pressure is not exerted by the finger. And in turn, no signal is transmitted to the processor. Further, speaker or LED indicator will not be activated to audibly or visually alert user. In this regard, the user may think that the touch pad malfunctions or there is poor contact among electrical components. To the worse, some users may think such products are poor in quality. This can cause users to have a bad impression to the manufacture of the product. Thus, the need for improvement still exists.

### SUMMARY OF THE INVENTION

It is therefore one object of the invention to provide a touch pad having a contact layer formed of resistive or piezoelectric material disposed between a first conduction layer and a second conduction layer so that even a slight finger pressing on the touch pad can generate a touch signal.

To achieve the above and other objects, the invention provides a touch pad comprising a bottom substrate formed of plastic material; a second conduction layer adhered to the bottom substrate; a plurality of spaced pressing structures formed on the second conduction layer and each comprising a sensing layer adhered to the second conduction layer, a contact layer formed of flexible resistive or piezoelectric material and adhered to the sensing layer, and a connection layer adhered to the contact layer; a first conduction layer adhered to the pressing structures; and a top substrate formed of plastic material and adhered to the first conduction layer.

The above and other objects, features and advantages of the invention will become apparent from the following detailed description taken with the accompanying drawings.

### BRIEF DESCRIPTION OF THE DRAWINGS

FIG. 1 is a perspective view of a touch pad according to the invention with a finger touching thereon;

FIG. 2 is a sectional view taken along line A-A of FIG. 1;

FIG. 3 is a block diagram showing the controller how to process a touch signal received from the pressing structure according to the invention;

FIG. 4 is a view similar to FIG. 2 showing a recess on the touch pad formed by a touch on a character or numeral of the top printing layer corresponding to a single pressing structure; and

FIG. 5 is a view similar to FIG. 4 showing two recesses on the touch pad formed by a touch on a character or numeral of the top printing layer corresponding to a plurality of pressing structures.

### DETAILED DESCRIPTION OF THE INVENTION

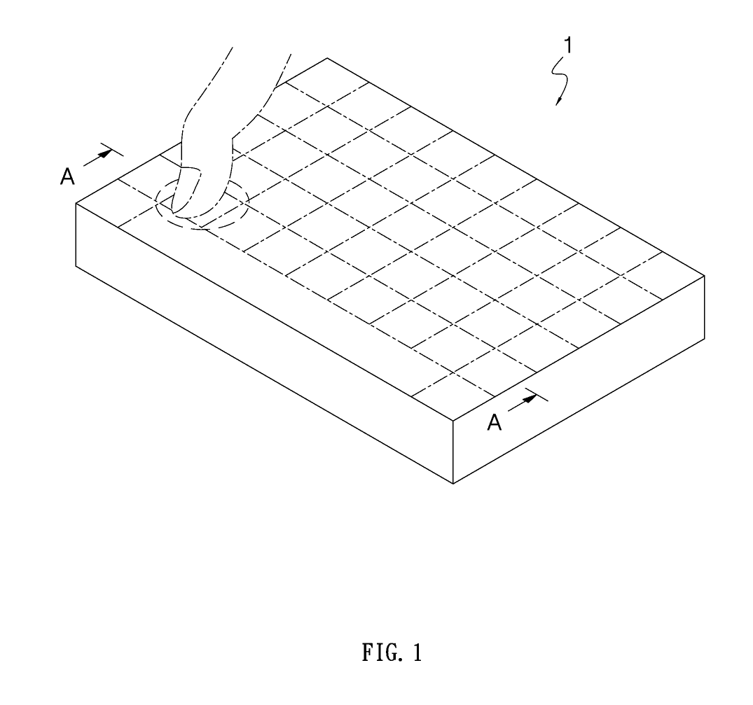

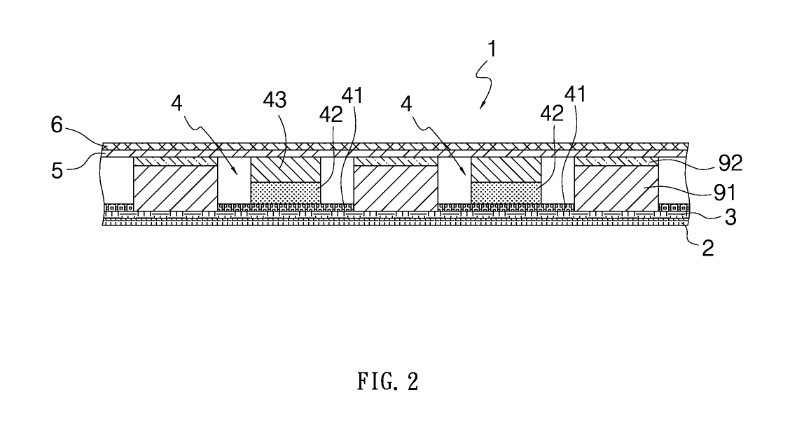

Referring to FIGS. 1 to 5, a touch pad 1 in accordance with the invention is shown. The touch pad 1 comprises the following components as discussed in detail below.

A bottom substrate 2 is, for example in one embodiment, formed of PET (polyethylene terephthalate). A second conduction layer 3 is adhered to the bottom substrate 2. A plurality of spaced pressing structures 4 are formed on the second conduction layer 3. A first conduction layer 5 is adhered to the pressing structures 4. A top substrate 6 is adhered to the first conduction layer 5.

The pressing structure 4 comprises a lower wide sensing layer 41 formed of sensing material (e.g., conductor or semiconductor material) and adhered to the second conduction layer 3, an intermediate narrow contact layer 42 formed of flexible resistive or piezoelectric material and adhered to the sensing layer 41, and an upper narrow connection layer 43 adhered to the contact layer 42.

As described above, the contact layer 42 can be formed of resistive material. This means that electrical resistance of the contact layer 42 may change in response to pressure applied thereon. Such resistance change is greatly significant when the sensing layer 41 is formed of semiconductor material.

Alternatively, the contact layer 42 is formed of piezoelectric material. Piezoelectricity is the charge which accumulates in certain solid materials (e.g., crystals) in response to applied mechanical strain. Piezoelectricity is the direct result of the piezoelectric effect. In detail, the nature of the (direct) piezoelectric effect is closely related to the occurrence of electric dipole moments in solids. The latter may either be induced for ions on crystal lattice sites with asymmetric charge surroundings or may directly be carried by molecular groups. The dipole density or polarization may easily be calculated for crystals by summing up the dipole moments per volume of the crystallographic unit cell. As every dipole is a vector, the dipole density is also a vector or a directed quantity. Dipoles near each other tend to be aligned in regions called Weiss domains. The domains are usually randomly oriented, but can be aligned during poling, a process by which a strong electric field is applied across the material, usually at elevated temperatures.

Polarization will be changed when applying a mechanical stress. This might either be caused by a re-configuration of the dipole-inducing surrounding or by re-orientation of molecular dipole moments under the influence of the external stress. Piezoelectricity may then manifest in a variation of the polarization strength, its direction or both, with the details depending on the orientation within the crystal, crystal symmetry, and the applied mechanical stress. The change in polarization appears as a variation of surface charge density upon the crystal faces, i.e. as a variation of the electrical field extending between the faces, since the units of surface charge density and polarization are the same. Piezoelectric materials also show the opposite effect, called converse piezoelectric effect, where the application of an electrical field creates mechanical deformation in the crystal.

As described above, the first conduction layer 5 is adhered to the pressing structures 4 (i.e., the connection layer 43). Both the top and bottom substrates 6, 2 are formed of PET in which the top substrate 6 is adhered to the first conduction layer 5.

Moreover, a printing layer (not numbered) is adhesively attached on the top substrate 6. The printing layer comprises a plurality of characters and/or numerals as virtual keys arranged in matrix and printed thereon. Each character or numeral corresponds to a pressing structure 4 disposed thereunder. That is, a pressing of the character or numeral may activate the pressing structure 4. Alternatively, each character or numeral corresponds to a plurality of pressing structures 4. That is, a pressing of the character or numeral may activate a plurality of pressing structures 4.

For the purposes of increasing the structural strength of the touch pad 1, there are provided a plurality of spacers 91 between the top substrate 6 and the bottom substrate 2. The spacer 91 has a bottom adhered to the second conduction layer 3 and a top secured to the first conduction layer 5 by means of a thin adhesive layer 92. The spacers 91 and the pressing structures 4 are arranged transversely in alternating fashion.

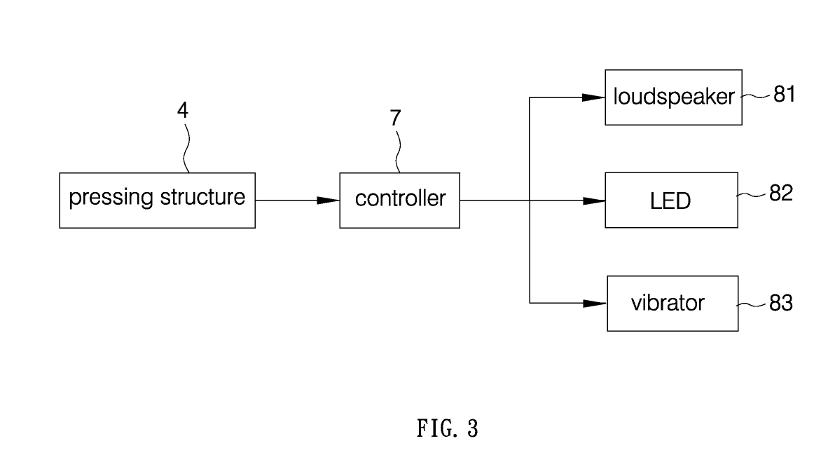

Referring to FIG. 3 specifically, it is a block diagram showing the controller 7 how to process a touch signal received from the pressing structure 4 according to the invention. The sensing layer 41 of the pressing structure 4 is electrically connected to the controller 7 which is in turn electrically connected to a loudspeaker 81, an LED (light-emitting diode) 82, and/or a vibrator 83 respectively as detailed later.

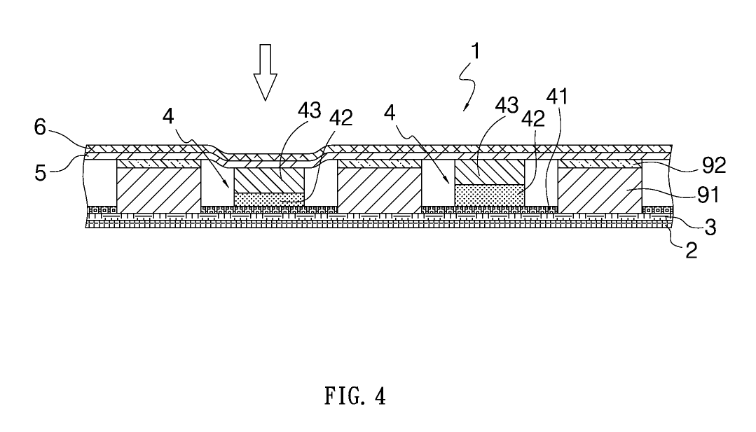

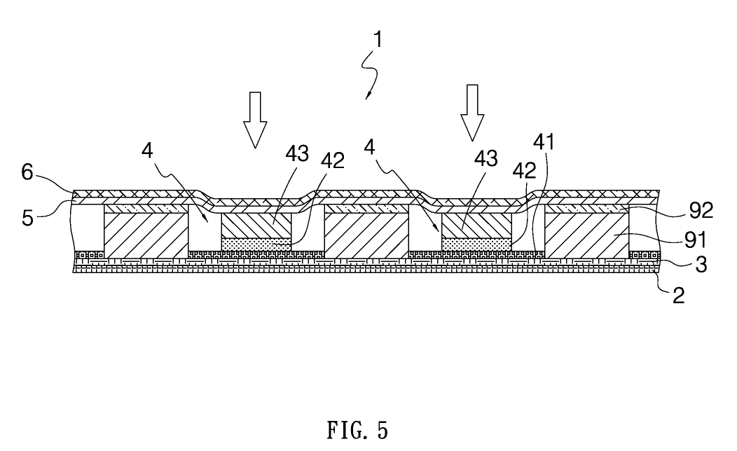

Referring to FIGS. 4 and 5 specifically, in which FIG. 4 shows a recess on the top substrate 6 formed by a touch on a character or numeral of the top printing layer corresponding to a single pressing structure 4 thereunder, and FIG. 5 shows two recesses on the top substrate 6 formed by a touch on a character or numeral of the top printing layer corresponding to a plurality of pressing structures 4 thereunder as detailed below.

As shown in FIG. 4, a user may place a finger (e.g., index finger) on the printing layer on the top substrate 6 and press a virtual key of the printing layer representing a character or numeral which is disposed above the pressing structure 4. The contact layer 42 is compressed in response to the exerted force. Electrical resistance of the contact layer 42 will be changed if the contact layer 42 is formed of resistive material. And in turn, the sensing layer 41 may sense the resistance change of the contact layer 42. A touch signal will be generated if the resistance change exceeds a threshold voltage value. And in turn, the touch signal is sent from the touch pad 1 to a processor of a computer (not shown). The threshold voltage value can be altered by running a program on the computer so as to accommodate different finger forces exerted by different users. As shown in FIG. 3, the touch signal will be transmitted from the pressing structure 4 to the controller 7. And in turn, the controller 7 may activate the loudspeaker 81 to make sound, activate the LED 82 to light or flash, or activate the vibrator 83 to vibrate as an indication of the touch signal being received and processed.

As shown in FIG. 5, likewise a user may place a finger (e.g., index finger) on the printing layer on the top substrate 6 and press a virtual key of the printing layer representing a character or numeral which is disposed above the pressing structurew 4. Two recesses are formed and two contact layers 42 are compressed in response to the exerted force. Electrical resistances of the contact layers 42 will be changed if the contact layers 42 are formed of resistive material. And in turn, the sensing layers 41 may sense the resistance change of the contact layers 42. A touch signal will be generated if the resistance change exceeds a threshold voltage value. And in turn, the touch signal is sent from the touch pad 1 to a subsequent device for processing the same as that described in the previous paragraph.

In brief, the invention has the following advantages and characteristics. A user may input data via the virtual keys of the touch pad by pressing without the aid of a typical computer keyboard. This can save the desktop space. Typical resistive touch pad comprises two spaced sensing layers without any support therebetween. To the contrary, the touch pad 1 of the invention has the pressing structures 4 sandwiched between the first conduction layer 5 and the second conduction layer 3 as support. Hence, no or a minimum number of spacers 91 are provided in alternating fashion with respect to the pressing structures 4 as support between the top substrate 6 and the bottom substrate 2. This can greatly decrease the manufacturing cost and enable a user to exert a minimum force on the touch pad for touch signal generation. Moreover, visual or audio prompt or both can be issued for alerting a successful touch.

While the invention has been described in terms of preferred embodiments, those skilled in the art will recognize that the invention can be practiced with modifications within the spirit and scope of the appended claims.

What is claimed is:

1. A touch pad comprising:
a bottom substrate formed of plastic material;
a second conduction layer adhered to the bottom substrate;
a plurality of spaced pressing structures formed on the second conduction layer and each of the pressing structures comprising a sensing layer adhered to the second conduction layer, a contact layer formed of flexible resistive or piezoelectric material and adhered to the sensing layer, and a connection layer adhered to the contact layer;
a first conduction layer adhered to the pressing structures; and
a top substrate formed of plastic material and adhered to the first conduction layer.

2. The touch pad of claim 1, further comprising a plurality of spacers each having a bottom adhered to the second conduction layer and a top secured to the first conduction layer by means of an adhesive layer, and wherein the spacers and the pressing structures are arranged transversely in alternating fashion.

3. The touch pad of claim 1, wherein the sensing layer is electrically connected to a controller.

4. The touch pad of claim 3, wherein the controller is further electrically connected to a loudspeaker, an LED (light-emitting diode), and/or a vibrator.

5. The touch pad of claim 1, further comprising a printing layer adhesively attached on the top substrate, the printing layer comprising a plurality of characters and/or numerals as virtual keys.

6. The touch pad of claim 5, wherein each character or numeral corresponds to at least one pressing structure.

7. The touch pad of claim 1, wherein the plastic material of each of the top and bottom substrates is PET (polyethylene terephthalate).

8. The touch pad of claim 1, wherein the sensing layer is formed of sensing material.
